(19) United States
(12) Patent Application Publication
(10) Pub. No.: US 2012/0024476 A1
(43) Pub. Date: Feb. 2, 2012

(54) METHOD AND DEVICE FOR HEATING CORRUGATED CARDBOARD SHEET

(75) Inventor: Kazuhito Ohira, Hiroshima (JP)

(73) Assignee: MITSUBISHI HEAVY INDUSTRIES PRINTING & PACKAGING MACHINERY, LTD., Hiroshima (JP)

(21) Appl. No.: 13/260,361

(22) PCT Filed: Mar. 30, 2010
(86) PCT No.: PCT/JP2010/055689

§ 371 Date: Sep. 25, 2011

(30) Foreign Application Priority Data
Apr. 9, 2009 (JP) 2009-095327

(51) Int. Cl. B32B 37/14; B32B 38/08; B32B 37/06

(52) U.S. Cl. 156/322; 156/390; 156/356

(57) ABSTRACT

A device for manufacturing a corrugated cardboard sheet includes a conveyor which conveys a corrugated medium and a liner, a starch applicator which is arranged along a conveying path of the corrugated medium and the liner and applies liquid starch to flute tops of the corrugated medium, a bonding unit which bonds the liner and the corrugated medium by placing the liner on the corrugated medium to which the liquid starch is applied and by heating and pressing the corrugated medium and the liner to gelatinize the liquid starch; and a spraying unit which is arranged on an upstream side of the bonding unit and sprays moist air on the flute tops of the corrugated medium to which the liquid starch is applied.

The present Application is the U.S. National Stage of International Application No. PCT/JP2010/055689, filed on Mar. 30, 2010, published in English; which Application claims priority benefit of Japanese Application No. 2009-095327, filed Apr. 9, 2009.

### TECHNICAL FIELD

The present invention relates to a method and device for preheating a flute top of a corrugated medium prior to a step of gluing the corrugated medium and a liner in a process of manufacturing a corrugated cardboard sheet by means of a single facer or a double facer.

### BACKGROUND ART

A corrugated cardboard sheet is manufactured by transferring a containerboard such as a corrugated medium, a backside liner and a surface liner between a variety of rollers and belts. First, the corrugated medium is formed by traveling through a pair of corrugated rolls with corrugated surfaces in a single facer. A liquid starch made by mixing dry starch with water, is applied to a flute top of the corrugated medium. The corrugated medium and the backside liner are bonded together and then heated and pressed to form a single faced corrugated cardboard sheet.

Next, in a double face located on a downstream side of the single facer in a conveying direction of the containerboard, the liquid starch is applied to a flute top of the corrugated medium of the single faced corrugated cardboard sheet. The single faced corrugated cardboard sheet and the surface liner are bonded together and then heated and pressed from both sides thereof to form a double faced corrugated cardboard sheet. To manufacture a double wall corrugated cardboard sheet, at least two single faced corrugated cardboard sheets and a surface liner are glued and bonded together at a time.

To improve the bonding of the liners and the flute top of the corrugated medium, it is necessary to balance water contained in the liquid starch and a thermal dose applied to the liquid starch. Specifically, it is necessary to gelatinize the liquid starch by heating the liquid starch to the gelatinization temperature after allowing the liquid starch to sufficiently penetrate in the bonding area of the flute top of the corrugated medium and the liner. The starch is gelatinized to generate adherence property. After the starch becomes adhesive, the gelatinized liquid starch is dried.

If the heating temperature is too high, the liquid starch becomes gelatinized before sufficiently penetrating through the corrugated medium and the liner in the bonding area. This results in adhesion bonding failure, which causes the medium and the liner to peel off from each other due to insufficient gelatinization of the liquid starch.

To improve the production efficiency of the corrugated cardboard sheet, the transferring speed of each containerboard is increased. The transferring speed is increased up to 350 to 400 m/min for a single faced corrugated cardboard sheet and 300 to 350 m/min for a double wall corrugated cardboard sheet.

Therefore, it is now difficult to control the heating and pressuring of each containerboard during the production process.

In the double facer, prior to bonding the single faced corrugated cardboard sheet and the surface liner, the single faced corrugated cardboard sheet and the surface liner are winded around a preheat roll for preheating. Next, the liquid starch is applied to the single faced corrugated cardboard sheet and the surface liner. The single faced corrugated cardboard sheet and the surface liner are put on top of each other and then heated by steam and pressed between a flat heat plate heated by steam and a pressure belt while being transferred. The heating and pressing of the heat plate gelatinizes the liquid starch and dries the bonding area. Saturated steam of normally 1.0 to 1.1 Mpa is supplied to the inside of the heat plate. The top surface of the heat plate is heated to 170 to 180° C.

Patent Document 1 (JP2007-30171A) discloses a method of heating in the double facer. According to the heating method, superheated steam is applied to the flute top of the corrugated medium after applying liquid starch and before heating and pressing the corrugated medium with the liner. The sprayed superheated steam gelatinizes the liquid starch and thus, the heating step by means of the heat plate is no longer necessary.

In the single face, prior to bonding the corrugated medium and the backside liner, the corrugated medium and the backside liner are winded around the preheat roll to be preheated. Then the steam is supplied into the corrugating roll so as to heat the corrugated medium while being bonded with the backside liner. The steam supplied to the corrugating roller is saturated steam that has the same pressure and temperature as the heat plate.

Patent Document 2 (JP2000-25131A) discloses a method of heating the single faced corrugated cardboard sheet in the single facer. According to the heating method, auxiliary heating is performed to meet the increased transferring speed of the containerboard. The auxiliary heat is performed in such a manner that the steam is sprayed to the flute top of the corrugated medium after applying the liquid starch so as to promote the gelatinization of the liquid starch.

### Citation List

### [Patent Document]

### [PATENT DOCUMENT 1] JP2007-30171A

### [PATENT DOCUMENT 2] JP2000-25131A

### SUMMARY OF INVENTION

### Technical Problem

The gelatinization temperature of the liquid starch is around 60° C., normally in the range of 57 to 62° C. The liquid starch needs to be heated to the temperature range to be gelatinized.

Meanwhile, the production of the corrugated cardboard sheet is mainly small lot production. The small lot production requires frequent changing of production conditions such as paper quality of a containerboard and a transferring speed (production speed). Accordingly, in the single facer and the double facer, it is necessary to change the following conditions every few minutes such as the amount of each containerboard to be wrapped around the preheat roll and a heating temperature of the corrugating roll and the heat plate.

To avoid wasting paper during the process of changing the production conditions, it is necessary to adjust the heating temperature setting to a temperature of updated production conditions. However, in the heating methods disclosed in Patent Document 1 and Patent Document 2, it is difficult to promptly change the production conditions.

The steam used in the above methods is 100° C. under atmospheric pressure and thus, the liquid starch is likely to be heated beyond the gelatinization temperature. Heating the liquid starch too high causes the liquid starch to be dry before sufficiently penetrating in the containerboards. This results in the adhesion bonding failure mentioned above.

If the steam is sprayed under reduced pressure, the temperature is below 100° C. However, this requires a pressure reducing device and thus, the cardboard production device becomes bigger and it is practically impossible to implement such device.

When the steam is used in the device, condensation tends to occur and mechanical parts tend to gather rust. The dew drop falls on the corrugated cardboard sheet, thereby causing the sheet to wrinkle and producing an inferior product.

In view of the problems above, an object of the present invention is to achieve a heating device which heats the liquid starch supplimentarily without using steam and also controls a temperature of the liquid starch to the gelatinization temperature without forming water drops during the production of the corrugated cardboard sheet.

### Solution to Problem

To achieve the object of the present invention, a method for manufacturing a corrugated cardboard sheet, may include, but not limited to, the steps of: applying liquid starch to flute tops of a corrugated medium; bonding the corrugated medium and a liner by placing the liner on the corrugated medium to which the liquid starch is applied and by heating and pressing the corrugated medium and the liner to gelatinize the liquid starch; and prior to the step of bonding, preheating the flute tops of the corrugated medium to which the liquid starch is applied by spraying moist air to the flute tops.

In the above method, prior to the step of bonding, the flute tops of the corrugated medium to which the liquid starch is applied is preheated by spraying the moist air thereto. In the case where the flute tops of the corrugated medium where the liquid starch is applied has a temperature not greater than the dew-point temperature, the moist air condenses in contact with the flute tops of the corrugated medium while releasing the latent heat of condensation onto the liquid starch, thereby heating the liquid starch. In contrast, in the case where the flute tops of the corrugated medium to which the liquid starch is applied has a temperature not less than the dew-point temperature, the vapor in the moist air does not condense and thus, the latent heat of condensation is not released onto the liquid starch.

The latent heat of condensation has greater amount of heat than sensible heat of the moist air. The latent heat of condensation is applied to the liquid starch, thereby enhancing heating effect. Meanwhile, the liquid starch is not heated beyond the dew-point temperature of the moist air. Thus, in comparison to the case of using steam, the overheating of the liquid starch is prevented and the quality deterioration of the product such as the adhesion bonding failure is solved.

The liquid starch is not excessively heated, which allows the heating time to be set with plenty of leeway. Thus, even when the conveying speed of the paper web is reduced, the heating can be performed accurately.

In the above method, it is preferable that the moist air has a dew point temperature that is within ±5° C. of a gelatinization temperature of the liquid starch. In this case, the moist air has the dew point near the gelatinization temperature. Thus, if the temperature of the flute tops of the corrugated medium to which the liquid starch is applied is not greater than the dew-point temperature, the moist air condenses in contact with the flute tops of the corrugated medium while releasing the latent heat of condensation onto the liquid starch g, thereby heating the liquid starch g.

In the case where the flute tops of the corrugated medium to which the liquid starch is applied has a temperature not less than the dew-point temperature, the vapor in the moist air does not condense and thus, the latent heat of condensation is not applied to the liquid starch g.

As a result, the liquid starch is heated accurately to the gelatinization temperature by the moist air and not beyond approximately the gelatinization temperature. Thus, the overheating of the liquid starch is prevented and the quality deterioration of the product such as the adhesion bonding failure is solved.

In the above method, it is preferable that the moist air has a temperature that is 10° C. to 100° C. higher than a gelatinization temperature of the liquid starch. Even when the temperature of the moist air decreases to some extent, no water drop is formed. Thus, there is no concern for inferior products which are generated due to formation of rust in the mechanical parts or the dew drops falling on the double wall corrugated cardboard sheet.

In the present invention, it is also preferable that the corrugated cardboard sheet includes one of a single faced corrugated cardboard sheet made at a single facer, a double faced corrugated cardboard sheet made at a double facer and a double wall corrugated cardboard sheet made at the double facer. In the production process of the double wall corrugated cardboard sheet, it is hard to conduct the heat from the heat plates to an upper corrugated cardboard sheet of the double wall corrugated cardboard sheet. In the present invention, the upper corrugated cardboard sheet is directed heated by the moist air prior to the bonding. Thus, the upper corrugated cardboard sheet can be sufficiently heated.

The present invention also provides a device for manufacturing a corrugated cardboard sheet. The device may include, but is not limited to: a conveyor which conveys a corrugated medium and a liner; a starch applicator which is arranged along a conveying path of the corrugated medium and the liner and applies liquid starch to flute tops of the corrugated medium; a bonding unit which bonds the liner and the corrugated medium by placing the liner on the corrugated medium to which the liquid starch is applied and by heating and pressing the corrugated medium and the liner to gelatinize the liquid starch; and a spraying unit which is arranged on an upstream side of the bonding unit and sprays moist air on the flute tops of the corrugated medium to which the liquid starch is applied.

In the above device of the present invention, the spraying unit sprays the moist air on the flute tops of the corrugated medium to which the liquid starch is applied. Similar to the aforementioned method of the present invention, it is possible to enhance the heating effect and prevent the overheating of the liquid starch in comparison of using the steam. As a result, the quality deterioration of the product such as the adhesion bonding failure is solved.

In the above device, it is preferable that the moist air has a dew point temperature that is within ±5° C. of a gelatinization temperature of the liquid starch.

By using the moist air, the liquid starch is accurately heated to the gelatinization temperature and the overheating of the liquid starch is prevented by not heating the liquid starch beyond the gelatinization temperature. As a result, the quality deterioration of the product such as the adhesion bonding failure is solved.

In the above device, the spray unit may include, but not limited to: a blower which supplies air to a steam heater; the steam heater which heats the supplied air by a steam; a mixing chamber which mixes the heated air and a steam to produce the moist air; a discharge part which is arranged to face a conveying path of the corrugated medium and through which the moist air is sprayed to the flute tops of the corrugated medium; a sensor unit comprising a pressure meter, a temperature meter and one of a dew-point meter and a steam partial pressure meter which are arranged in a passage for the moist air between the mixing chamber and the discharge part; and a controller which controls a flow amount of the air and the steam to the steam heater and the mixing chamber by inputting values detected by the sensor unit.

With the above structure, the air can be supplied to the steam heater by the air delivery fan instead of compressing the air and pumping it to the steam heater. Thus, it is not necessary to make component devices and pipes pressure-proof and the structure can be simplified.

Further, the moist air having a desired dew-point temperature can be accurately produced with use of the controller.

### Effect of the Invention

According to the method of the present invention for manufacturing the corrugated cardboard sheet, the method may include, but not limited to, the steps of: applying liquid starch to flute tops of a corrugated medium; bonding the corrugated medium and a liner by placing the liner on the corrugated medium to which the liquid starch is applied and by heating and pressing the corrugated medium and the liner to gelatinize the liquid starch; and prior to the step of bonding, preheating the flute tops of the corrugated medium to which the liquid starch is applied by spraying moist air to the flute tops. The liquid starch is heated with use of the latent heat of condensation of the vapor contained in the moist air and thus, it is possible to improve the heating effect and to prevent the overheating of the liquid starch in comparison to using steam by not heating the liquid starch beyond the dew-point of the moist air.

Therefore, the quality deterioration of the product such as the adhesion bonding failure is solved. The heating time can be set with plenty of leeway. Thus, even when the conveying speed of the paper web is reduced, the heating accuracy can be improved.

According to the device of the present invention for manufacturing the corrugated cardboard sheet, the device may include, but is not limited to: a conveyor which conveys a corrugated medium and a liner; a starch applicator which is arranged along a conveying path of the corrugated medium and the liner and applies liquid starch to flute tops of the corrugated medium; a bonding unit which bonds the liner and the corrugated medium by placing the liner on the corrugated medium to which the liquid starch is applied and by heating and pressing the corrugated medium and the liner to gelatinize the liquid starch; and a spraying unit which is arranged on an upstream side of the bonding unit and sprays moist air on the flute tops of the corrugated medium to which the liquid starch is applied. As a result, it is possible to achieve the same operational effects as the method of the present invention.

### BRIEF DESCRIPTION OF DRAWINGS

FIG. 1 is a partial front view of a double facer in relation to a first preferred embodiment of the present invention.

FIG. 1 is a block diagram of a moist air spraying unit of the first preferred embodiment of the present invention.

FIG. 1 is a front view of a single facer in relation to a second preferred embodiment of the present invention.

### DESCRIPTION OF EMBODIMENTS

A preferred embodiment of the present invention will now be described in detail with reference to the accompanying drawings. It is intended, however, that unless particularly specified, dimensions, materials, shape, its relative positions and the like shall be interpreted as illustrative only and not limitative of the scope of the present invention.

### First Preferred Embodiment

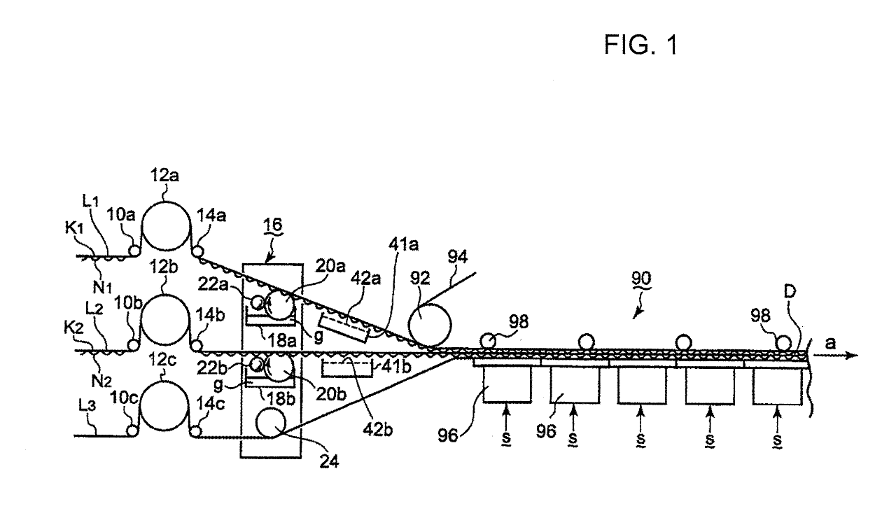

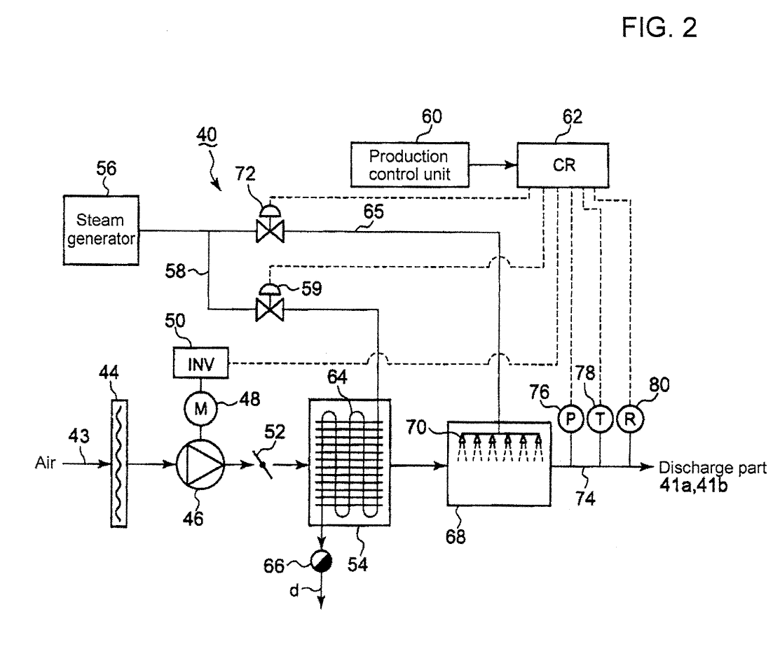

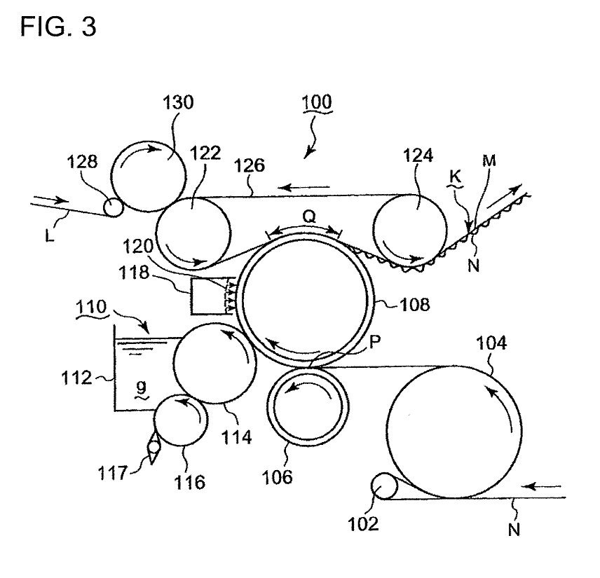

A first preferred embodiment of the present invention, which is applied to a production process of a double wall corrugated cardboard sheet made at a double facer, is explained in reference to FIG. 1 and FIG. 2.

In FIG. 1, two single faced corrugated cardboard sheets K₁ and K₂ and a surface liner L₃ are transferred in the direction of the arrow a. The single faced corrugated cardboard sheet K₁ or K₂ is manufactured at a single-facer (unshown) arranged on an upstream side in the conveying direction by gluing a backside liner L₁ or L₂ to flute tops of the corrugated medium N₁ or N₂.

The single faced corrugated cardboard sheets K₁ and K₂ and the surface liner L₃ are respectively winded around preheat rolls 12a to 12c by guide rolls 10a to 10c and 14a to 14c to preheat the sheets. The preheat rolls 12a to 12c have a steam generator 56 inside as a heat source. The steam generator supplies steam to the preheat rolls 12a to 12c. The details of the steam generator 56 are described later.

The single faced corrugated cardboard sheets K₁ and K₂ and the surface liner L₃ having been heated by the preheat rolls 12a to 12c are transferred to a gluing unit 16.

The gluing unit 16 has applicator rolls 20a 20b and glue trays 18a and 18b along the conveying path of the single faced corrugated cardboard sheets K₁ and K₂. The glue trays 18a and 18b stores liquid starch g inside. Lower parts of the applicator rolls 20a and 20b are immersed in the liquid starch. The top surfaces of the applicator rolls 20a and 20b are in contact with the flute tops of the single faced corrugated cardboard sheet K₁ and K₂. Thus, the liquid starch g is applied to the flute tops of the corrugated medium of the single faced corrugated cardboard sheets K₁ and K₂ by rotating the applicator rolls 20a and 20b.

The gluing unit 16 also includes doctor rolls 22a and 22b which are in contact with the applicator rolls 20a and 20b. The doctor rolls 22a and 22b rotate in the same direction with the applicator rolls 20a and 20b respectively so as to adjust the amount of the liquid starch to be applied to the applicator rolls 20a and 20b.

The surface liner L₃ in the gluing unit 16 is guided to a double facer 30 by a guide roll 24.

Moist air discharge parts 41a and 41b are arranged along the conveying path of the single faced corrugated cardboard sheets K₁ and K₂ between the double facer 90 and the gluing unit 16. The moist air is discharged from the discharge parts 41a and 41b which constitute a part of a moist air spraying unit 40 shown in FIG. 2.

The moist air discharge parts 41a and 41b are shaped into a container. In the discharge part 41a and 41b, supplied is moist air whose absolute humidity and enthalpy are adjusted so that the dew point temperature is near the gelatinization temperature of the liquid starch g.

The moist air whose dew-point temperature is adjusted to the gelatinization temperature of the liquid starch g is sprayed to the flute tops of the corrugated media of the single faced corrugated cardboard sheets K₁ and K₂ from the moist air discharge parts 41a and 41b. The liquid starch g applied to the flute tops are gelatinized. The bonding part of the flute tops of the corrugated media N₁ and N₂ and the backside liners L₁ and L₂ is in an uncured-bonding state.

Next, the single faced corrugated cardboard sheets K₁ and K₂ and the surface liner L₃ are conveyed to the double facer 90. The double facer 90 has a guide roll 92 at an inlet thereof. A belt conveyor 94 is installed about the guide roll 92 and extends in the conveying direction of each paper web, i.e. the direction indicated with the arrow a. A plurality of heat plates 96 are arranged below the belt conveyor 94 along the conveying direction. A top surface of each heat plate 96 is formed flat. The paper web is conveyed over the flat surfaces of the heat plates 96.

The heat plates 96 are arranged over a certain distance, e.g. 7 to 8 meters. Saturated steam s of 1.0 to 1.1 Mpa is supplied to the heat plates 96 and the top surfaces of the heat plates 96 are heated to 170 to 180° C. A plurality of pressure rolls 98 are arranged on a rear side of the belt conveyor 94 along the conveying direction. The pressure rolls 98 presses the paper web being conveyed over the heat plates 96.

The single faced corrugated cardboard sheets K₁ and K₂ and the surface liner L₃ are conveyed over the heat plates in a state of being stacked together and pressed and heated.

The liquid starch g is applied to the flute tops of the corrugated media of the single faced corrugated cardboard sheets K₁ and K₂. The liquid starch g is heated by the moist air sprayed from the moist air discharge parts 41a and 41b and reaches the gelatinization temperature and is in the uncured-bonding state at the inlet of the double facer 90. Then, the liquid starch g is further heated by traveling over the heat plates 76 in the double facer 90 to bond together and dry the single faced corrugated cardboard sheets K₁ and K₂ and the surface liner L.

The configuration of the moist air spraying unit 40 is explained in reference to FIG. 2. As shown in FIG. 2, the air is introduced to a pipe line 43 by a air delivery fan (or a blower) via a filter 44 which filters foreign substances of the air. The air delivery fan 46 is driven by a drive motor 48. An inverter 50 controls the rotation of the drive motor 48 to control the atmospheric pressure in the pipe line 43. The inverter 50 is controlled by a controller 62. A damper 52 is installed in the pipe line 43 to adjust the air flow.

The controller 62 controls the inverter 50, a temperature regulating valve 59 and a moisture regulating valve 72 according to operation conditions such as paper types (basic weight (weight of the paper per 1m²) and the conveying speed of the paper web which are stored in a production control unit 60.

A steam heater 54 is installed on a downstream side of the damper 52. A steam pipe 58 is connected to the steam heater 54 to supply the steam generated in the steam generator to the steam heater 54 via the steam pipe 58. The temperature regulating valve 59 is installed in the steam pipe 58 to adjust the temperature of the air in the steam heater 54 by adjusting the flow rate of the steam in the steam pipe 58. The steam generator 56 also supplies steam to the preheat rolls 12a to 12c and the heat plates 96.

The steam pipe 58 is connected to a meandering pipe 64 inside the steam heater 54. The steam streams in the meandering pipe 64 and heat the air. The meandering pipe 64 is connected to a steam trap 66 outside the steam heater 54. The steam is condensed in the steam trap 66 to discharge water d and is discharged outside.

The heated air is sent to a mixing chamber 68. The steam generator 56 and the mixing chamber 68 are connected via the steam pipe 65. The mixing chamber 68 has a plurality of injection nozzles connected to the steam pipe 65. The injection nozzles 70 are decentrally-disposed inside the mixing chamber 68. The steam is injected from the injection nozzles 70 in the mixing chamber 68 so as to produce the most air. The moisture regulating valve 72 is installed in the steam pipe 65 so as to adjust the partial pressure of the steam in the moist air by regulating the flow rate of the steam in the steam pipe 65.

A pressure meter 76, a temperature meter and one of a dew-point meter and a steam partial pressure meter 80 are installed in a discharge pipe 74 of the mixing chamber 68. These measuring devices measure the pressure, temperature and steam partial pressure of the moist air streaming in the discharge pipe 74. The measured values are inputted to the controller 62. The controller 62 controls the rotation of the drive motor 48 by means of the inverter 50 and the opening of the temperature regulating valve 59 or the moisture regulating valve 72 based on the measured values.

By this, the dew-point temperature of the moist air produced in the mixing chamber 68 becomes near the gelatinization temperature of the liquid starch g. The temperature of the moist air is controlled to be 10° C. to 100° C. higher than the dew-point temperature.

The moist air produced in the mixing chamber 68 is supplied to the moist air discharge parts 41a and 41b. The moist air discharge parts 41a and 41b have discharge panels 42a and 42b respectively. The discharge panels 42a and 42b are made of punching metal having slit-like holes which are arranged to face the corrugated medium of the single faced corrugated cardboard sheets K₁ and K₂ respectively. The moist air is sprayed at the flute tops of the corrugated media through the discharge panels 42a and 42b.

In the above structure, the dew-point temperature of the moist air sprayed through the discharge panels 42a and 42b is set near the gelatinization temperature of the liquid starch g. Thus, in the case where the flute tops of the corrugated medium where the liquid starch is applied has a temperature not greater than the dew-point temperature, the moist air condenses in contact with the flute tops of the corrugated media while releasing the latent heat of condensation onto the liquid starch g, thereby heating the liquid starch g. In contrast, in the case where the flute tops of the corrugated medium to which the liquid starch is applied has a temperature not less than the dew-point temperature, the vapor in the moist air does not condense and thus, the latent heat of condensation is not released onto the liquid starch g.

In this manner, the liquid starch g is heated to approximately the gelatinization temperature on the upstream side of the double facer 90 and gelatinized to be in the uncured-bonding state. Next, the webs are transferred over the heat plates 96 in the double facer 90 where the webs are heated and pressed. Then, the corrugated media N and the backside liner L are bonded and dried and the double wall corrugated cardboard sheet D is produced.

According to the preferred embodiment, it is possible to heat the liquid starch g accurately to near the gelatinization temperature by the moist air. It is also possible to avoid overheating of the liquid starch g as the liquid starch g is not heated beyond the gelatinization temperature. Therefore, quality deterioration of the product such as the adhesion bonding failure is solved.

The latent heat of the condensation of the vapor contained in the moist air is released onto the liquid starch g so as to heat the liquid starch g. Thus, the heating effect is improved.

As described above, the liquid starch g is not heated beyond the gelatinization temperature, which allows the heating time to be set with plenty of leeway. Thus, even when the conveying speed of the paper web is reduced, the heating accuracy can still be improved.

The moist air has a temperature that is 10° C. to 100° C. higher than the gelatinization temperature of the liquid starch. Even when the temperature of the moist air decreases to some extent, no water drop is formed. Thus, there is no concern for inferior products which are generated due to formation of rust in the mechanical parts or the dew drops falling on the double wall corrugated cardboard sheet.

The moist water discharge parts 41a and 41b are provided so as to lessen the required heating power of the preheat roll 12a to 12c or the heat plates 96.

The moist air spraying unit 40 of FIG. 2 is provided. Thus, the air is supplied to the pipe line 43 by the air delivery fan 46 (or an air blower) instead of compressing the air and pumping it to the pipe line. Therefore, it is not necessary to make component devices and pipes pressure-proof and the structure can be simplified.

Further, the moist air having a desired dew-point temperature can be accurately produced with use of the controller 62.

### Second Preferred Embodiment

A second preferred embodiment of the present invention, which is applied to a production process of a single faced corrugated cardboard sheet made at a single facer, is explained in reference to FIG. 3.

In FIG. 3, the media N is reeled out from a paper roll unshown in the drawing. The media N is winded around the preheat roll 104 by the guide roll 102 so as to be preheated. The preheated medium N is carried to a engagement part P between a lower corrugating roll 106 and an upper corrugating roll 108 to produce the corrugated media N. The lower and upper corrugating rolls 106 and 108 have corrugating surfaces to engage with each other in the engagement part P. A gluing unit 110 is provided on a downstream side of the engagement part between the upper and lower rolls.

The gluing unit 110 has glue trays 112 in which the liquid starch g is stored, an applicator roll 114 whose lower part is immersed in the liquid starch g, a doctor roll 116 which is in contact with the applicator roll 114 and rotates in the opposite direction to the applicator roll 114 to adjust the amount of the liquid starch applied to the applicator roll 114, and a scraper 117 which scrapes the liquid starch g off from the doctor roll 116. The liquid starch g is applied to the flute tops of the corrugated media N by the applicator roll 114.

A moist air discharge part 118 is disposed to face the upper corrugated roll 108 on a downstream side of the gluing unit 110. The moist air discharge part 118 has the same structure as the moist air discharge parts 41a and 41b of the first preferred embodiment shown in FIG. 1 and has a discharge panel 120 which is arranged to face the upper corrugating roll 108. The discharge panel 120 is made of punching metal or the like. The moist air is supplied to the discharge part from a moist air spraying unit not shown. The moist air spraying unit has the same structure as the moist air spraying unit 40 shown in FIG. 2. In the same manner to the first preferred embodiment, the discharge panel 120 has slit-like holes along the direction of the flute tops of the corrugated medium N. The moist air having the dew-point temperature near the gelatinization temperature of the liquid starch g is sprayed through the slit-like holes to the flute tops of the corrugated medium N.

On a downstream side of the moist air discharge part 118, a pressure belt 126 is installed around a pair of pressure rolls 122 and 124. The pressure belt 126 is pressed against the upper corrugating roll 108 while moving in the direction of the arrow by the rotation of the pressure rolls 122 and 124. The downward force of the pressure belt 126 against the upper corrugating roll 108 is adjustable by changing a tensile force of the pressure belt 126. The tensile force of the pressure belt 126 can be changed by changing the distance between the pressure rolls 122 and 124.

The backside liner L is guided by a guide roll 128 and winded around a preheat roll 130. The backside liner L is preheated by the preheat roll 130 and placed on the pressure belt 126 installed around the pressure rolls and 124. Then, the backside liner L enters a nip area Q between the upper corrugating roll 108 and the pressure belt 126.

A steam generator unshown in the drawing supplies steam to the preheat rolls 104 and 130. The steam generator supplies steam to the lower corrugating roll 106 to preheat the corrugated medium N. The steam having the same temperature and pressure as the steam s supplied to the heat plates 96 of FIG. 1 is supplied to the upper corrugating roll 108 by the steam generator.

The moist air is sprayed to the flute tops of the corrugated medium N by the moist air discharge part 118 and the liquid starch g thereon is gelatinized into the uncured bonding state. The corrugating medium N in the uncured bonding state is fed to the nip area Q to be placed on the backside liner and pressed and heated together in the nip area Q. IN this manner, the corrugated medium N and the backside liner L are bonded and the bonding part is dried.

According to the second preferred embodiment, the liquid starch g is heated by the moist air having the dew-point temperature near the gelatinization temperature of the liquid starch g prior to the bonding of the corrugated medium N and the backside liner L. By this, the liquid starch g can be heated accurately to the gelatinization temperature but not beyond the gelatinization temperature. As a result, it is possible to achieve the same operation and effect as the first preferred embodiment, such as prevention of overheating of the liquid starch g.

### INDUSTRIAL APPLICABILITY

According to the present invention, it is possible in the production process of the corrugated cardboard sheet to heat the liquid starch accurately to the gelatinization temperature prior to the bonding of the corrugated cardboard sheet without forming water drops.

1-7. (canceled)

8. A method for manufacturing a corrugated cardboard sheet, comprising the steps of:
applying liquid starch to flute tops of a corrugated medium;
bonding the corrugated medium and a liner by placing the liner on the corrugated medium to which the liquid starch is applied and by heating and pressing the corrugated medium and the liner to gelatinize the liquid starch; and
prior to the step of bonding, preheating the flute tops of the corrugated medium to which the liquid starch is applied by spraying moist air to the flute tops.

9. The method for manufacturing the corrugated cardboard sheet according to claim 8,
wherein the moist air has a dew point temperature that is within ±5° C. of a gelatinization temperature of the liquid starch.

10. The method for manufacturing the corrugated cardboard sheet according to claim 8,
wherein the moist air has a temperature that is 10° C. to 100° C. higher than a gelatinization temperature of the liquid starch.

11. The method for manufacturing the corrugated cardboard sheet according to claim 9,
wherein the moist air has a temperature that is 10° C. to 100° C. higher than a gelatinization temperature of the liquid starch.

12. The method for manufacturing the corrugated cardboard sheet according to any one of claim 8,
wherein the corrugated cardboard sheet includes one of a single faced corrugated cardboard sheet made at a single facer, a double faced corrugated cardboard sheet made at a double facer and a double wall corrugated cardboard sheet made at the double facer.

13. A device for manufacturing a corrugated cardboard sheet, comprising:
a conveyor which conveys a corrugated medium and a liner;
a starch applicator which is arranged along a conveying path of the corrugated medium and the liner and applies liquid starch to flute tops of the corrugated medium;
a bonding unit which bonds the liner and the corrugated medium by placing the liner on the corrugated medium to which the liquid starch is applied and by heating and pressing the corrugated medium and the liner to gelatinize the liquid starch; and
a spraying unit which is arranged on an upstream side of the bonding unit and sprays moist air on the flute tops of the corrugated medium to which the liquid starch is applied.

14. The device for manufacturing the corrugated cardboard sheet according to claim 13,
wherein the moist air has a dew point temperature that is within ±5° C. of a gelatinization temperature of the liquid starch.

15. The device for manufacturing the corrugated cardboard sheet according to claim 13,
wherein the spray unit comprises:
a blower which supplies air to a steam heater;
the steam heater which heats the supplied air by a steam;
a mixing chamber which mixes the heated air and a steam to produce the moist air;
a discharge part which is arranged to face a conveying path of the corrugated medium and through which the moist air is sprayed to the flute tops of the corrugated medium;
a sensor unit comprising a pressure meter, a temperature meter and one of a dew-point meter and a steam partial pressure meter which are arranged in a passage for the moist air between the mixing chamber and the discharge part; and
a controller which controls a flow amount of the air and the steam to the steam heater and the mixing chamber by inputting values detected by the sensor unit.

16. The device for manufacturing the corrugated cardboard sheet according to claim 14,
wherein the spray unit comprises:
a blower which supplies air to a steam heater;
the steam heater which heats the supplied air by a steam;
a mixing chamber which mixes the heated air and a steam to produce the moist air;
a discharge part which is arranged to face a conveying path of the corrugated medium and through which the moist air is sprayed to the flute tops of the corrugated medium;
a sensor unit comprising a pressure meter, a temperature meter and one of a dew-point meter and a steam partial pressure meter which are arranged in a passage for the moist air between the mixing chamber and the discharge part; and
a controller which controls a flow amount of the air and the steam to the steam heater and the mixing chamber by inputting values detected by the sensor unit.
